(19) United States
(12) Patent Application Publication
(10) Pub. No.: US 2026/0213040 A1
(43) Pub. Date: Jul. 23, 2026

(54) SINGLE-PHASE BUSBAR SUITABLE FOR HIGH FREQUENCY SIGNALS AND MOTOR SYSTEM USE SAME

(71) Applicant: Delta Electronics, Inc., Taoyuan City (TW)

(72) Inventors: CHANG YI CHENG, Taoyuan City (TW); ZONG YOU JIANG, Taoyuan City (TW); KUAN YAO TSENG, Taoyuan City (TW); WEI TE SU, Taoyuan City (TW)

(21) Appl. No.: 19/181,395

(22) Filed: Apr. 17, 2025

(30) Foreign Application Priority Data
Jan. 17, 2025 (TW) 114101994

(51) Int. Cl. H01B 7/02

(52) U.S. Cl. CPC H01B 7/0208

(57) ABSTRACT

A single-phase busbar suitable for high-frequency signals and motor system. The single-phase busbar includes a plurality of conductive layers and a plurality of insulating layers extending from input end to output end. Between any two adjacent conductive layers is provided with at least one insulating layer. The conductive layers and the insulating layers are alternately stacked, and the conductive layers are at least electrically connected to each other at the input end and electrically connected to each other at the output end.

### CROSS-REFERENCE TO RELATED APPLICATIONS

This application claims priority to Taiwan Patent Application No. 114101994, filed on January 17, 2025, the disclosure of which is herein incorporated by reference in their entirety.

### FIELD

The disclosure relates to a busbar, and more particularly, to a single- phase busbar suitable for high frequency signals and a motor system use the same.

### BACKGROUND

A power busbar used to provide power to motor drive, etc. transmits high-frequency AC signals. Power busbars are generally stamped from a single piece of metal conductor. The power busbars that carry large currents heat up due to the inevitable resistance in the metal. In addition, operation of high- frequency current will intensify the skin effect of metal conductor, and the AC resistance of the power busbar will increase, resulting in increased voltage loss, reduced motor efficiency, and aggravated temperature rise of the power busbar. Therefore, there is a need to solve the above-mentioned issue of the power busbar.

### SUMMARY

In view of the above, the disclosure provides a single-phase busbar suitable for high frequency signals and a motor system use the same to effectively solve the issue of the power busbar in the prior art.

In order to achieve above-mentioned object of the disclosure, one embodiment of the disclosure provides a single-phase busbar suitable for high- frequency signals, including an input end and an output end. The single-phase busbar further includes: a plurality of conductive layers extending from the input end to the output end; and a plurality of insulating layers. Between any two adjacent conductive layers is provided with at least one insulating layer. The plurality of conductive layer and the plurality of insulating layer are alternately stacked, and the plurality of conductive layers are at least electrically connected to each other at the input end and electrically connected to each other at the output end.

In one embodiment, the single-phase busbar suitable for high- frequency signals further includes an electrical connection portion disposed at the input end or the output end and configured so that the plurality of conductive layers are electrically connected to each other through the electrical connection portion.

In one embodiment of the single-phase busbar suitable for high- frequency signals, the electrical connection portion is disposed through the plurality of insulating layers at the input end or the output end.

In one embodiment of the single-phase busbar suitable for high- frequency signals, the electrical connection portion covers the plurality of insulating layers and the plurality of conductive layers at the input end or the output end.

In one embodiment of the single-phase busbar suitable for high- frequency signals, an outermost layer of the single-phase busbar is a conductive layer.

Another embodiment of the disclosure provides a single-phase busbar suitable for high-frequency signals, including an input end and an output end. The single-phase busbar further includes: a plurality of conductive layers extending from the input end to the output end, a plurality of insulating layers, and at least one opening. Between any two adjacent conductive layers is provided with at least one insulating layer. The plurality of conductive layer and the plurality of insulating layers are alternately stacked. The at least one opening is provided to penetrating the plurality of conductive layers and the plurality of insulating layers alternately stacked. An extending direction of the at least one opening is consistent with a stacking direction of the plurality of conductive layer and the plurality of insulating layer at the location where the at least one opening is provided. The stacking direction is not parallel to an extending direction from the input end to the output end.

In one embodiment, the single-phase busbar suitable for high- frequency signals further includes an electrical connection portion arranged in the at least one opening and configured so that the plurality of conductive layers are electrically connected to each other through the electrical connection portion.

In one embodiment of the single-phase busbar suitable for high- frequency signals, the at least one opening is a circular hole.

In one embodiment of the single-phase busbar suitable for high- frequency signals, the at least one opening is a half hole.

Another embodiment of the disclosure provides a single-phase busbar suitable for high-frequency signals, including an input end and an output end. The single-phase busbar further includes: a plurality of conductive layers extending from the input end to the output end; and a plurality of insulating layer. Between any two adjacent conductive layers is provided with at least one insulating layer. The plurality of conductive layers and the plurality of insulating layers are alternately stacked, and the plurality of conductive layers are at least suitable for electrically connecting at the input end through an external terminal and electrically connecting at the output end through another external terminal.

In one embodiment of the single-phase busbar suitable for high- frequency signals, at least one opening is provided through the input end or the output end of the single-phase busbar and the at least one opening is suitable for securing with the external terminal.

In one embodiment of the single-phase busbar suitable for high- frequency signals, the single-phase busbar is elongated as a whole and a stacking direction of the plurality of conductive layer and the plurality of insulating layer is not parallel to the extending direction from the input end to the output end.

In one embodiment, the single-phase busbar suitable for high- frequency signals further includes at least one bent portion disposed between the input end and the output end.

Another embodiment of the disclosure provides a motor system including: an inverter, a motor, and a busbar unit. The inverter includes three output terminals for respectively outputting three-phase power. The motor includes three input terminals for respectively receiving the three-phase power output by the inverter. The busbar unit is electrically connected with the inverter and the motor. The busbar unit includes three single-phase busbars suitable for high-frequency signals. Each of the single-phase busbars includes an input end and an output end. Each of the single-phase busbars includes: a plurality of conductive layers extending from the input end to the output end; and a plurality of insulating layer. Between any two adjacent conductive layers is provided with at least one insulating layer. The plurality of conductive layers are alternately stacked with the plurality of insulating layers, and the plurality of conductive layers are at least electrically connected to each other through the output terminal at the input end and electrically connected to each other through the input terminal at the output end.

In one embodiment of the motor system, each of the single-phase busbars further includes at least one opening penetrating the plurality of conductive layers and the plurality of insulating layers alternately stacked, and an extending direction of the at least one opening is consistent with a stacking direction of the plurality of conductive layers and the plurality of insulating layers at a location where the at least one opening is penetrated, and the stacking direction is not parallel to an extending direction from the input end to the output end.

In one embodiment of the motor system, the at least one opening is a circular hole.

In one embodiment of the motor system, the at least one opening is a half hole.

In one embodiment of the motor system, each of the single-phase busbars further includes at least one fixing piece, the output terminal or the input terminal is provided with a through hole corresponding to the at least one opening, and the fixing piece is suitable for penetrating the at least one opening of the input end or the output end of the single-phase busbar and the through hole of the output terminal or the input terminal.

In one embodiment of the motor system, the plurality of conductive layers are at least electrically connected to each other at the input end and are electrically connected to each other at the output end.

In one embodiment of the motor system, the outermost layer of the single-phase busbar is a conductive layer.

In comparison with prior art, the disclosed single-phase busbar provides the plurality of conductive layers and the plurality of insulating layers alternately stacked to reduce skin effect of high-frequency signals, the AC resistance of the single-phase busbar, temperature rise, and voltage loss to enhance motor efficiency and avoid the issue in the prior art.

### BRIEF DESCRIPTION OF DRAWINGS

FIG. 1 is a schematic diagram of a three-dimensional structure of a single-phase busbar according to an embodiment of the present disclosure;

FIG. 2 is a schematic cross-sectional view of the single-phase busbar of the embodiment in FIG. 1;

FIG. 3 is a schematic diagram of a three-dimensional structure of a single-phase busbar according to another embodiment of the present disclosure;

FIG. 4 is a schematic cross-sectional view of the single-phase busbar of the embodiment in FIG. 3;

FIG. 5 is a schematic diagram of a three-dimensional structure of a single-phase busbar according to another embodiment of the present disclosure;

FIG. 6 is a schematic diagram of a three-dimensional structure of a single-phase busbar according to another embodiment of the present disclosure;

FIG. 7 is a partial enlarged schematic diagram of the dotted line frame in FIG. 6;

FIG. 8 is a schematic diagram of the assembly of a motor system according to one embodiment of the present disclosure;

FIG. 9 is a schematic diagram of an equivalent series resistance between a single-phase busbar according to an embodiment of the present disclosure and a conventional busbar versus signal frequency.

Reference numerals description:

10: inverter; 11: output terminal; 100: motor system; 20: motor; 21: input terminal; 30: busbar unit; 31, 31a, 31b, 31c: single-phase busbar; 32: conductive layer; 33: insulating layer; 34: electrical connection portion; 35, 35a, 35b: opening; 36: bent portion; 37: fixing piece; IE: input end; OE: output end; HL: through hole; X, Z: direction.

### DETAILED DESCRIPTION

In order to make the above and other objects, features, and advantages of the disclosure easier to understand, preferred embodiments of the disclosure will be illustrated below and described in detail with reference to the drawings. In addition, in the drawings, structurally similar units are represented by the same reference numerals.

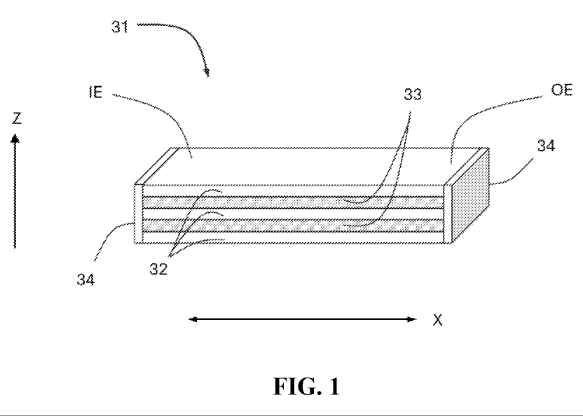

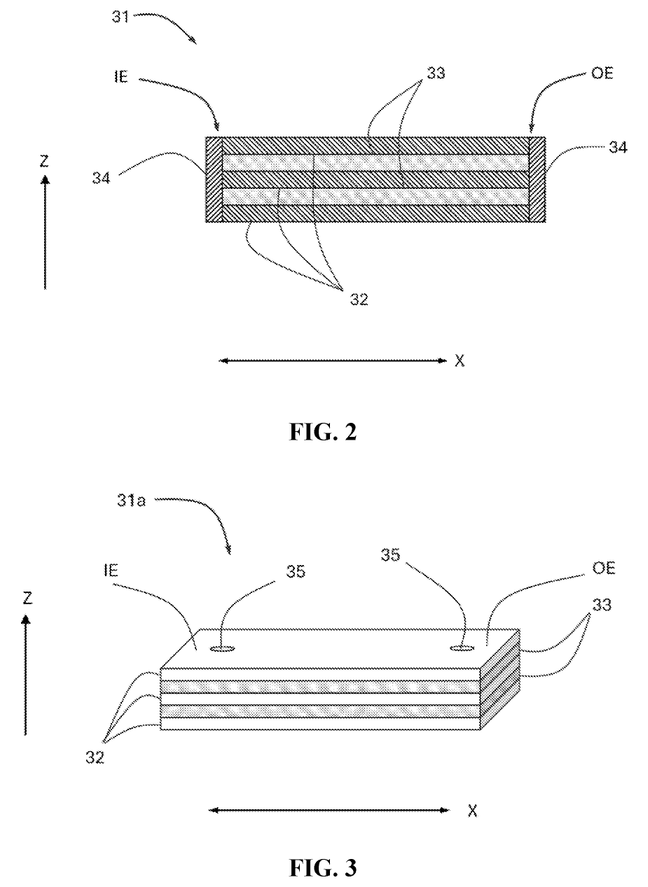

Referring to FIG. 1 and FIG. 2, FIG. 1 is a schematic diagram of a three-dimensional structure of a single-phase busbar according to an embodiment of the present disclosure. FIG. 2 is a schematic cross-sectional view of the single-phase busbar of the embodiment in FIG. 1. The present disclosure provides a single-phase busbar 31 suitable for high-frequency signals. The single-phase busbar 31 has an input end IE and an output end OE. The single-phase busbar 31 includes a plurality of conductive layers 32 extending from the input end IE to the output end OE; and a plurality of insulating layers 33. Between any two adjacent conductive layers 32 is provided with at least one insulating layer 33. The plurality of conductive layers 32 and the plurality of insulating layers 33 are alternately stacked and the plurality of conductive layers 32 are at least electrically connected to each other at the input end IE and electrically connected to each other at the output end QE.

In detail, material of the conductive layer 32 is, for example, metal, alloy, conductive semiconductor material, etc., which is not limited in the present disclosure. The material of the insulating layer 33 may be ceramic, resin, oxide (silicon dioxide, copper oxide, etc.), etc., and the present disclosure is not limited thereto.

In detail, the plurality of conductive layers 32 and the plurality of insulating layers 33 are arranged in an alternating manner, such as laminating metal foil and ceramic sheet, oxidizing copper foil and then pressing a plurality of copper foils with oxidized surfaces together, bonding a plurality of metal foils with resin, etc., which are not limited in the present disclosure.

In detail, the plurality of conductive layers 32 are at least electrically connected to each other at the input end IE and at least electrically connected to each other at the output end OE. For example, directly and electrically connect at the input end IE or at the output end OE by the conductive layer 32. Alternatively, another conductive material is used to electrically connect each conductive layer 32 together at the input end IE or at the output end OE. An equivalent parallel circuit that connects at circuit heads and connects at circuit tails is formed. Although replacing a whole conductor of a conventional busbar with the staggered stacking arrangement of the plurality of conductive layer 32 and the plurality of insulating layer 33 disclosed herein can effectively solve the skin effect of high-frequency signals, the resistance increases rapidly in single conductive layer 32 because the transmission cross-sectional area of the single conductive layer 32 becomes smaller. Therefore, the plurality of conductive layers 32 are at least electrically connected to each other at the input end IE and electrically connected to each other at the output end OE to form an equivalent parallel circuit, which helps to reduce the equivalent resistance.

The single-phase busbar 31 of one embodiment of the present disclosure further includes an electrical connection portion 34 disposed at the input end IE or the output end OE and configured such that the plurality of conductive layers 32 are electrically connected to each other through the electrical connection portion 34.

In detail, material of the electrical connection portion 34 can be the same as or different from the material of the conductive layer 32. The material of the electrical connection portion 34 is, for example, metal, alloy, conductive semiconductor material, etc., which is not limited in the present disclosure.

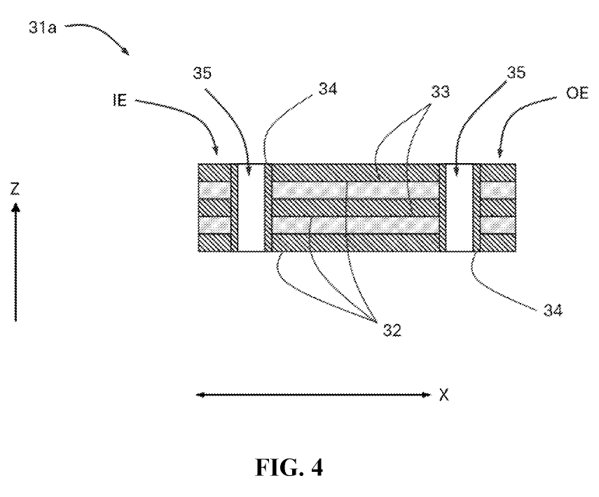

Refer to FIG. 3 and FIG. 4. FIG. 3 is a schematic diagram showing a three-dimensional structure of a single-phase busbar according to another embodiment of the present disclosure. FIG. 4 is a schematic cross-sectional view of the single-phase busbar of the embodiment in FIG. 3. In one embodiment of the present disclosure, the electrical connection portion 34 is disposed through the plurality of insulating layers 33 at the input end IE or at the output end OE.

In detail, the electrical connection portion 34 at the input end IE or the output end OE passes through the opening 35 formed in the single-phase busbar 31a to pass through the plurality of insulating layers 33 to electrically connect the plurality of conductive layers 32 together. The electrical connection portion 34 may be partially filled in the opening 35 or completely filled in the opening 35.

Refer to FIG. 1 and FIG. 2. In one embodiment of the present disclosure, the electrical connection portion 34 covers the plurality of insulating layers 33 and the plurality of conductive layers 32 at the input end IE or at the output end OE.

In detail, the materials of the plurality of conductive layers 32 can be different. For example, the material of the outermost conductive layer 32 is metal, such as copper, while the material of the conductive layer 32 located in the middle is conductive semiconductor. The material of the electrical connection portion 34 is also copper. The outermost conductive layer 32 and the electrical connection portion 34 are used to cover the plurality of stacked conductive layers 32 and the insulating layers 33 together and then die-cast to prevent the stacked conductive layers 32 and the insulating layer 33 from being scattered, so as to provide better structural strength.

In one embodiment of the present disclosure, the outermost layer of the single-phase busbar 31 is a conductive layer 32. In detail, in addition to providing better structural strength, making the outermost layer of the single- phase busbar 31 the conductive layer 32 can also provide the single-phase busbar 31 with a larger conductive area when connected to an external terminal, thereby reducing the resistance at the connection.

Referring to FIG. 3 and FIG. 4, the present disclosure further provides a single-phase busbar 31a suitable for high-frequency signals, including: a plurality of conductive layers 32 extending from an input end IE to an output end OE, a plurality of insulating layers 33, and at least one opening 35. Between any two adjacent conductive layers 32 is provided with at least one insulating layer 33. The plurality of conductive layer 32 and the plurality of insulating layer 33 are alternately stacked. The at least one opening 35 penetrates the plurality of conductive layers 32 and the plurality of insulating layers 33 that are alternately stacked, and an extending direction of the opening 35 is consistent with a stacking direction Z of the plurality of conductive layers 32 and the plurality of insulating layers 33 where the opening 35 penetrates. At least part of the stacking directions Z is not parallel to an extending direction X from the input end IE to the output end OE.

In detail, the extending direction of the opening 35 has a significant correlation with the structural strength and conductivity (or resistivity) of the single-phase busbar 31a. If the extending direction of the opening 35 is perpendicular to the stacking direction Z, the single-phase busbar 31a may have a weaker structural strength and a higher resistivity.

In detail, the stacking direction Z is almost not parallel to the extending direction X from the input end IE to the output end OE. For example, as shown in FIG. 3 or FIG. 4, the stacking direction Z and the extending direction X from the input end IE to the output end OE are perpendicular to each other. In some embodiments, the single-phase busbar may be bent as required, so the stacking direction Z and the direction X from the input end IE to the output end OE may not be exactly perpendicular to each other. However, preferably, if each conductive layer 32 can be set to extend from the input end IE to the output end OE as much as possible, each conductive layer 32 can play the function of conducting electricity, which can significantly reduce the resistance of the single-phase busbar.

In one embodiment of the present disclosure, an electrical connection portion 34 is disposed in the opening 35, and the electrical connection portion 34 is configured that the plurality of conductive layers 32 are electrically connected to each other through the electrical connection portion 34. In detail, the electrical connection portion 34 passes through the opening 35 formed in the single-phase busbar 31 a at the input end IE or the output end OE to pass through the plurality of insulating layer 33 to electrically connect with the plurality of conductive layers 32 together. The electrical connection portion 34 may be partially filled in the opening 35 or completely filled in the opening 35.

In one embodiment of the present disclosure, the opening 35 is a circular hole. In detail, the opening 35 is preferably a circular through hole that passes through the single-phase busbar 31 a.

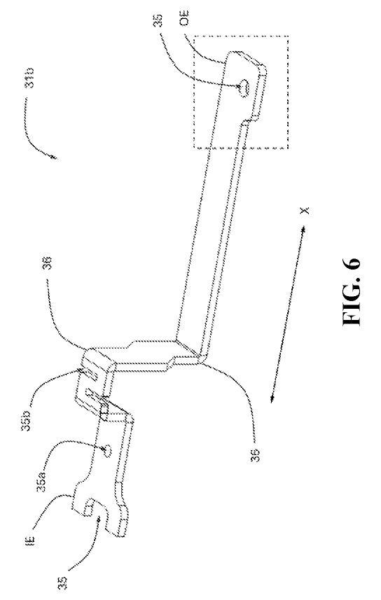

In one embodiment of the present disclosure, the opening 35 is a half hole. In detail, referring to the opening 35b in FIG. 6, it is illustrated as an open semi-hole structure.

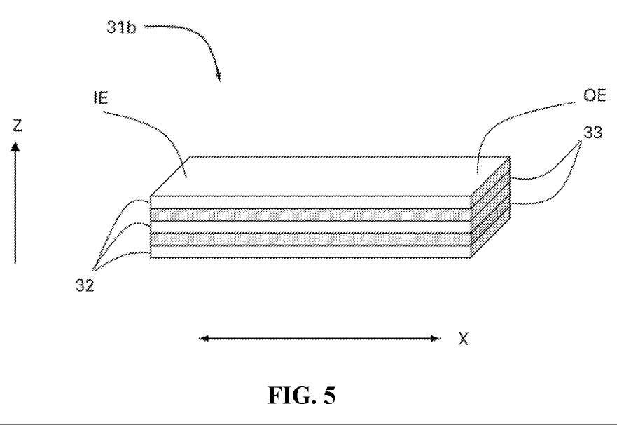

Referring to FIG. 5, FIG. 5 is a schematic diagram showing a three- dimensional structure of a single-phase busbar according to another embodiment of the present disclosure. The present disclosure further provides a single-phase busbar 31b suitable for high-frequency signals, including: a plurality of conductive layers 32 extending from an input end IE to an output end OE; and a plurality of insulating layers 33. Between any two adjacent conductive layers 32 is provided with at least one insulating layer 33. The plurality of conductive layers 32 and the plurality of insulating layers 33 are alternately stacked and the plurality of conductive layers 32 are at least suitable for being electrically connected at the input end IE or at the output end OE through external terminals.

In detail, the electrical connection of the plurality of conductive layer 32 of the single-phase busbar 31b at the input end IE or at the output end QE can be provided by a structure other than the single-phase busbar 31b.

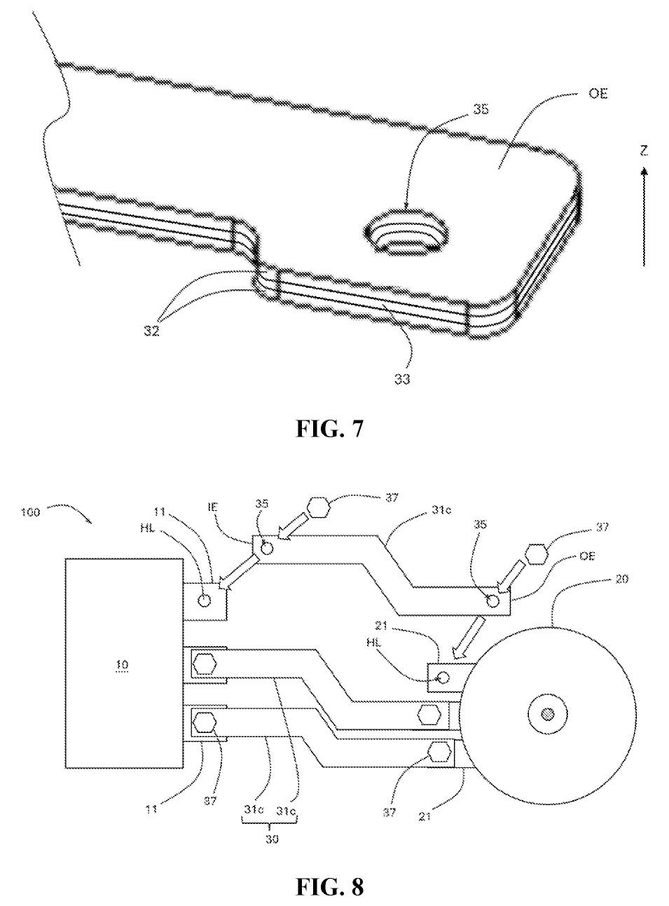

Refer to FIG. 6 and FIG. 7. FIG. 6 is a schematic diagram showing a three-dimensional structure of a single-phase busbar according to yet another embodiment of the present disclosure. FIG. 7 is a schematic diagram showing an enlarged portion of the dotted line frame in FIG. 6. In one embodiment of the present disclosure, at least one opening 35 is disposed through the input end IE or the output end OE of the single-phase busbar 31b and the opening 35 is configured to be fixed with the external terminal.

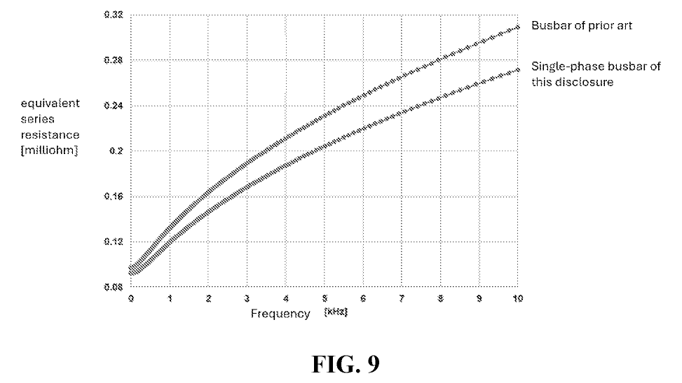

In detail, the external terminal may refer to the output terminal 11 or the input terminal 21 of FIG. 8. It refers to a terminal structure out of the single- phase busbar 31 b.

In detail, as can be seen from the enlarged view of FIG. 7, the single- phase busbar 31b includes at least two conductive layers 32 sandwiching an insulating layer 33. The present disclosure does not impose any limitation on the number of the conductive layers 32 and the number of the insulating layers 33. However, at least two conductive layers 32 are required to sandwich one insulating layer 33.

In one embodiment of the present disclosure, the single-phase busbar 31 b is elongated as a whole and the stacking direction Z of the plurality of conductive layer 32 and the plurality of insulating layer 33 is mainly not parallel to the extending direction X from the input end to the output end. In detail, the single-phase busbar 31 b is an overall flat and long structure.

The single-phase busbar 31b of one embodiment of the present disclosure further includes at least one bent portion 36 disposed between the input end IE and the output end OE.

Refer to FIG. 8. FIG. 8 is a schematic diagram showing an assembly of a motor system 100 according to an embodiment of the present disclosure. The present disclosure further provides a motor system 100, which includes an inverter 10, a motor 20, and a busbar unit 30. The inverter 10 includes three output terminals 11 that respectively output three-phase power. The motor 20 includes three input terminals 21 for respectively receiving the three-phase power output by the inverter. The busbar unit 30 electrically connects with the inverter 10 and the motor 20. The busbar unit 30 includes three single-phase busbar bars 31c. Each of the single-phase busbars 31c includes a plurality of conductive layers 32 extending from the input end IE to the output end OE; and a plurality of insulating layers 33. Between any two adjacent conductive layers 32 is provided with at least one insulating layer 33. The plurality of conductive layer 32 and the plurality of insulating layer 33 are alternately stacked and the plurality of conductive layer 32 is at least electrically connected at the input end IE through the output terminal 11 and electrically connected at the output end OE through the input terminal 21.

In detail, please refer to FIG. 1 to FIG. 6 and their corresponding descriptions for the input end IE, the output end OE, the conductive layer 32, and the insulating layer 33, which will not be repeated here.

In detail, the plurality of conductive layer 32 is electrically connected at least at the input end IE through the output terminal 11, for example, using a conductive screw or clamp to fix the input end IE and the output terminal 11 together and electrically connect them to each other. The conductive screws or clamps are fixed with the input end IE and the output terminal 11, such that the conductive screws or clamps are electrically connected to each conductive layer 32.

In detail, the plurality of conductive layer 32 is electrically connected at least at the output end OE through the input terminal 21, for example, using a conductive screw or clamp to fix the output end OE and the input terminal 21 together and electrically connect them to each other. After the conductive screws or clamps are fixed to the output end OE and the input terminal 21, they are electrically connected to each conductive layer 32.

In one of the embodiments of the disclosure, each of the single- phase busbars 31 c further includes at least one opening 35 penetrating through the plurality of conductive layers 32 and the plurality of insulating layers 33 that are staggered and stacked, and an extending direction of the at least one opening 35 is consistent with a stacking direction Z of the plurality of conductive layers 32 and the plurality of insulating layers 33 where the at least one opening 35 is penetrated. The stacking direction Z is mainly not parallel to an extending direction X from the input end IE to the output end OE.

In detail, for the conductive layer 32, the insulating layer 33, the extending direction of the opening 35, the stacking direction Z, the direction X, etc., please refer to FIG. 1 to FIG. 6 and their corresponding descriptions, which will not be repeated here.

In one embodiment of the present disclosure, the opening 35 is a circular hole. For details, please refer to FIG. 6 and its corresponding description, which will not be repeated here.

In one embodiment of the present disclosure, the opening 35 is a half hole. For details, please refer to FIG. 6 and its corresponding description, which will not be repeated here.

In one embodiment of the present disclosure, each of the single- phase busbars 31 c further includes at least one fixing piece 37, and the output terminal 11 or the input terminal 21 is provided with a through hole HL corresponding to the at least one opening 35. The fixing piece 37 is suitable for penetrating the at least one opening 35 of the input end IE or the output end OE of the single-phase busbar 31c and the through hole HL of the output terminal 11 or the input terminal 21.

In detail, the material of the fixing piece 37 is metal, for example. The fixing piece 37 is, for example, a metal screw.

In one embodiment of the present disclosure, the plurality of conductive layers 32 are at least electrically connected to each other at the input end IE and are electrically connected to each other at the output end OE. In detail, please refer to FIGS. 1 to 6 and their corresponding descriptions for the input end IE, the output end OE, the conductive layer 32, and the insulating layer 33, which will not be described in detail here.

In one embodiment of the present disclosure, the outermost layer of the single-phase busbar 31c is a conductive layer 32. In detail, please refer to FIGS. 1 to 6 and their corresponding descriptions for the input end IE, the output end OE, the conductive layer 32, and the insulating layer 33, which will not be described in detail here.

Referring to FIG. 9, FIG. 9 is a schematic diagram showing a curve of equivalent series resistance versus signal frequency of a single-phase busbar according to an embodiment of the present disclosure and a conventional busbar. As can be seen from the figure, when the frequency of the signal transmitted by the conventional busbar increases, the equivalent series resistance also increases. However, the single-phase busbar using the disclosed technology has a lower equivalent series resistance.

In comparison with prior art, the disclosed single-phase busbar provides the plurality of conductive layers and the plurality of insulating layers alternately stacked to reduce skin effect of high-frequency signals, the AC resistance of the single-phase busbar, temperature rise, and voltage loss to enhance motor efficiency and avoid the issue in the prior art.

The above description is to illustrate the characteristics of the disclosure through preferred embodiments. The purpose is to enable those skilled in the art to understand the content of the disclosure and implement it accordingly, but not to limit the patent scope of the application. Therefore, any other equivalent modifications or modifications that do not depart from the technical ideas disclosed in this application shall still be included in the claim scope described below.

What is claimed is:

1. A single-phase busbar suitable for high-frequency signals, including an input end and an output end, wherein the single-phase busbar comprises:
a plurality of conductive layers extending from the input end to the output end; and
a plurality of insulating layers, wherein between any two adjacent conductive layers is provided with at least one insulating layer, the plurality of conductive layer and the plurality of insulating layer are alternately stacked, and the plurality of conductive layers are at least electrically connected to each other at the input end and electrically connected to each other at the output end.

2. The single-phase busbar suitable for high-frequency signals of claim 1 further comprising an electrical connection portion disposed at the input end or the output end and configured so that the plurality of conductive layers are electrically connected to each other through the electrical connection portion.

3. The single-phase busbar suitable for high-frequency signals of claim 2 wherein the electrical connection portion is disposed through the plurality of insulating layers at the input end or the output end.

4. The single-phase busbar suitable for high-frequency signals of claim 2 wherein the electrical connection portion covers the plurality of insulating layers and the plurality of conductive layers at the input end or the output end.

5. The single-phase busbar suitable for high-frequency signals of claim 1 wherein an outermost layer of the single-phase busbar is a conductive layer.

6. A single-phase busbar suitable for high-frequency signals, including an input end and an output end, wherein the single-phase busbar comprises:
a plurality of conductive layers extending from the input end to the output end;
a plurality of insulating layers, wherein between any two adjacent conductive layers is provided with at least one insulating layer, and the plurality of conductive layer and the plurality of insulating layers are alternately stacked; and
at least one opening penetrating the plurality of conductive layers and the plurality of insulating layers alternately stacked, wherein an extending direction of the at least one opening is consistent with a stacking direction of the plurality of conductive layer and the plurality of insulating layer at the location where the at least one opening is provided.

7. The single-phase busbar suitable for high-frequency signals of claim 6 further comprising an electrical connection portion arranged in the at least one opening and configured so that the plurality of conductive layers are electrically connected to each other through the electrical connection portion.

8. The single-phase busbar suitable for high-frequency signals of claim 6 wherein the at least one opening is a circular hole.

9. The single-phase busbar suitable for high-frequency signals of claim 6 wherein the at least one opening is a half hole.

10. A single-phase busbar suitable for high-frequency signals, including an input end and an output end, the single-phase busbar comprising:
a plurality of conductive layers extending from the input end to the output end; and
a plurality of insulating layer, wherein between any two adjacent conductive layers is provided with at least one insulating layer, the plurality of conductive layers and the plurality of insulating layers are alternately stacked, and the plurality of conductive layers are at least suitable for electrically connecting at the input end through an external terminal and electrically connecting at the output end through another external terminal.

11. The single-phase busbar suitable for high-frequency signals of claim 10. The single-phase busbar suitable for high-frequency signals ofwherein at least one opening is disposed through the input end or the output end of the single-phase busbar and the at least one opening is suitable for securing with the external terminal.

12. The single-phase busbar suitable for high-frequency signals of claim 10. The single-phase busbar suitable for high-frequency signals of wherein the single-phase busbar is elongated as a whole.

13. The single-phase busbar suitable for high-frequency signals of claim 10 further includes at least one bent portion disposed between the input end and the output end.

14. A motor system comprising:
an inverter, comprising three output terminals for respectively outputting three-phase power;
a motor, comprising three input terminals for respectively receiving the three-phase power output by the inverter; and
a busbar unit, electrically connected with the inverter and the motor,
wherein the busbar unit includes three single-phase busbars suitable for high-frequency signals, each of the single-phase busbars includes an input end and an output end, and each of the single-phase busbars includes:
a plurality of conductive layers extending from the input end to the output end; and
a plurality of insulating layer, wherein between any two adjacent conductive layers is provided with at least one insulating layer, the plurality of conductive layers are alternately stacked with the plurality of insulating layers, and the plurality of conductive layers are at least electrically connected to each other through the output terminal at the input end and electrically connected to each other through the input terminal at the output end.

15. The motor system of claim 14, wherein each of the single-phase busbars further comprises at least one opening penetrating the plurality of conductive layers and the plurality of insulating layers alternately stacked, and an extending direction of the at least one opening is consistent with a stacking direction of the plurality of conductive layers and the plurality of insulating layers at a location where the at least one opening is penetrated.

16. The motor system of claim 15, wherein the at least one opening is a circular hole.

17. The motor system of claim 15, wherein the at least one opening is a half hole.

18. The motor system of claim 15, wherein each of the single-phase busbars further comprises at least one fixing piece, the output terminal or the input terminal is provided with a through hole corresponding to the at least one opening, and the fixing piece is suitable for penetrating the at least one opening of the input end or the output end of the single-phase busbar and the through hole of the output terminal or the input terminal.

19. The motor system according to claim 14, wherein the plurality of conductive layers are at least electrically connected to each other at the input end and are electrically connected to each other at the output end.

20. The motor system of claim 14, wherein the outermost layer of the single- phase busbar is a conductive layer.
